(19) United States
(12) Patent Application Publication
(10) Pub. No.: US 2026/0211383 A1
(43) Pub. Date: Jul. 23, 2026

(54) NATURAL LANGUAGE GENERATIVE AI INTERFACE FOR A HOME AUTOMATION SYSTEM

(71) Applicant: Savant Systems, Inc., Hyannis, MA (US)

(72) Inventors: Robert P. Madonna, Osterville, MA (US); Arthur A. Jacobson, Long Lake, MN (US); Alejandro Orellana, Mashpee, MA (US); Evan Cornell, Chesterfield, VA (US); Gary M. Baldino, Sandwich, MA (US); Peter H. Corsini, East Sandwich, MA (US); Gabriel Diamant, Brighton, MA (US); Christopher Lawrence, Hamden, CT (US); Brian Sylvia, Sandwich, MA (US); Atulya Shetty, Orlando, FL (US); Alex Wiggins, Portland, OR (US)

(21) Appl. No.: 19/452,564

(22) Filed: Jan. 19, 2026

Related U.S. Application Data
(60) Provisional application No. 63/747,072, filed on Jan. 19, 2025.

(51) Int. Cl. G05B 13/02; G06F 3/16; G06F 40/30

(52) U.S. Cl. CPC G05B 13/027; G06F 3/167; G06F 3/165; G06F 40/30

(57) ABSTRACT

In one embodiment, a home automation interface device (e.g., an in-wall or table-top keypad, a smartphone, a remote control, a remote control base station, etc.) is used as an interface for accessing processes and/or agents that include a generative AI engine. The home automation interface device receives natural language input from a user indicating a desired change to a home automation service, and passes the natural language input to processes and/or agents that include the generative AI engine. The generative AI engine produces structured data including function calls and/or service requests with related arguments, and processes and/or agents then cause the function calls and/or service requests to be executed by a home automation controller to implement the desired change to the home automation service. The home automation interface device may itself also function as the home automation controller.

### RELATED APPLICATIONS

This Application claims the benefit of U.S. Provisional Patent Application No. 63/747,072 filed Jan. 19, 2025 by Robert Madonna et al. for a “Natural Language Generative AI Interface for a Home Automation System”, the contents of which are incorporated by reference herein in their entity.

### BACKGROUND

### Technical Field

The present disclosure relates generally to home automation systems and more specifically to integration of natural language artificial intelligence (AI) interfaces into home automation systems.

### Background Information

As homes and other structures become larger, and become filled with more devices, controlling them becomes an increasing challenge. Traditionally, many devices have been controlled by individual mechanical switches and knobs. While mechanical switches and knob are reliable and cost-effective, they have many limitations. More recently, a variety of types of home automation systems have been developed that attempt to improve upon the shortcomings of mechanical switches. Such systems typically include a dedicated home automation controller that manages the operation home automation services provided by interoperating groups of devices. A home automation controller is often interacted with via programmable buttons and/or on-screen graphic icons provided by home automation interface devices (e.g., keypads, smartphones, remote controls, etc.). In such manner, a button-centric and/or graphic icon-centric user interface is provided for the home automation system.

However, such a button-centric and/or graphic icon-centric user interface shares many of the same shortcomings as mechanical switches and knobs. While a button may be programmable, and a graphic icon may be shown in a graphical user interface (GUI), the user experience is rather similar to using a mechanical switch or knob. By looking at a button or graphic icon it may not be readily apparent what the button or graphic icon does, what type of change to a home automation service it will cause, etc. While a label may be provided, often such labels are short and cryptic. Likewise, if a user desires to implement a more complex type of change to a home automation service, the user may need to know a precise scheme for interacting with many buttons or graphic icons, in a particular order, with specific settings, to achieve the desired results.

AI provides opportunities for implementing easy-to-use natural language-based user interfaces that may address many of the shortcomings of button-centric and/or graphic icon-centric user interfaces. It would be desirable to integrate a natural language AI interface into home automation systems. However, existing implementations of natural language AI interfaces suffer a number of shortcomings. Typically, such implementations require a dedicated natural language interface device and/or a dedicated home automation controller with considerable processing capabilities. Such requirements increase installation costs and hinder the integration of AI into existing home automation systems. Likewise, such implementations often have limited capabilities. For example, they may be only capable of controlling a particular type of home automation service, or may be only capable of implementing a limited subset of changes for home automation services.

Accordingly, there is a need for improved techniques for integrating natural language AI interfaces into home automation systems.

### SUMMARY

In various embodiments, a home automation interface device that performs other home automation functions is used as an interface for accessing processes and/or agents that include a generative AI engine. The home automation interface device receives natural language input from a user indicating a desired change to a home automation service, and passes the natural language input to processes and/or agents that include the generative AI engine. The generative AI engine produces structured data including function calls and/or service requests with related arguments, and the processes and/or agents then cause the function calls and/or service requests to be executed by a home automation controller to implement the desired change to the home automation service.

Depending on the embodiment, the form of the home automation interface device and the other home automation functions it performs may differ. For example, the home automation interface device may be an in-wall or table-top keypad that also provides a button-centric user interface, and may, for example, also include a load control relay or dimming circuit configured to adjust power supplied to a lighting device coupled thereto. Alternatively, the home automation interface device may be a smartphone executing a control application (app) that also provides a graphical icon-centric user interface. Likewise, the home automation interface device may be a remote control, or a remote control base station that also provides charging functionality, for example, includes a remote control charging circuit and charging contacts for charging a remote control. Similarly, the home automation interface device may be an electrical panel controller that also provides energy monitoring and management services, for example, communicates with and/or controls one or more breakers or companion modules in a load center to monitor and manage power supplied to loads. Further, the home automation interface device may be an embedded wakeword device that is configured to transition from passive listening to active processing in response to a specific phase.

The home automation interface device may itself also function as the home automation controller, and include processing capabilities for executing the function calls and/or service requests to implement the desired change to the home automation service. Alternatively, the home automation controller may be a separate device. Depending on the embodiment, the form of a separate home automation controller may differ. For example, the separate home automation controller may be a keypad (where the home automation interface device is a device other than a keypad). Likewise, the home automation controller may be a dedicate home automation controller.

The processes and/or agents that include the generative AI engine may be disposed, in whole or in part, on different local devices, or in the cloud, with the architecture depending on the embodiment. For example, in various architectures, the majority of the components of the processes and/or agents may be disposed locally on the home automation interface device that received the natural language input from the user. Alternatively, in a distributed multi-agent architecture, components of the processes and/or agents may be distributed locally among several home automation interface devices, home automation controllers, other hardware devices, and/or in the cloud. For instance, at least some components of the processes and/or agents may be distributed locally among the home automation interface device that received the natural language input from the user and other home automation interface devices (e.g., ones that did not receive the natural language input directly from the user). Likewise, at least some of the components of the processes and/or agents may be distributed to a separate home automation controller, other hardware device, or to the cloud.

In one specific embodiment, a method is provided for controlling a home automation service. A home automation interface device receives natural language input from a user indicating a desired change to the home automation service, wherein the home automation interface device is a keypad, a smartphone, a remote control or remote control base unit, or an electrical panel controller. The home automation interface device passes the natural language input to processes and/or agents that include a generative AI engine executing on one or more cloud-based or local computing devices. The generative AI engine produces structured data, wherein the structured data describes one or more function calls and/or service requests and one or more arguments for the change to the home automation service. The home automation interface device provides the structured data to a home automation controller, wherein the home automation controller is the keypad, the remote control or remote control base unit, an electrical panel controller, or a dedicated home automation controller. The home automation controller executes the one or more function calls and/or service requests to implement the desired change to the home automation service.

In another specific embodiment, a keypad is provided to control a home automation service. The keypad includes one or more buttons for receiving user input, one or more communications interfaces, and an application processor. The application processor is configured to receive, via the one or more communications interfaces from a device that includes a microphone, natural language input from a user indicating a desired change to the home automation service, and to pass, via the one or more communications interfaces, the natural language input to a generative AI engine. The application processor is configured to receive, via the one or more communications interfaces, structured data back from the generative AI engine, wherein the structured data describes one or more function calls and/or service requests and one or more arguments for the change to the home automation service. The application processor is configured to execute the one or more function calls and/or service requests to implement the desired change to the home automation service.

In another specific embodiment, a remote control base unit is provided to control a home automation service. The remote control base unit includes a remote control charging circuit and charging contacts for charging a remote control, one or more communications interfaces, and an application processor. The application processor is configured to receive, via the one or more communications interfaces from a device that includes a microphone, natural language input from a user indicating a desired change to the home automation service, and to pass, via the one or more communications interfaces, the natural language input to a generative AI engine. The application processor is configured to receive, via the one or more communications interfaces, structured data back from the generative AI engine, wherein the structured data describes one or more function calls and/or service requests and one or more arguments for the change to the home automation service. The application processor is configured to execute the one or more function calls and/or service requests to implement the desired change to the home automation service.

It should be understood that a wide variety of additional features and alternative embodiments may be implemented other than those discussed in this Summary. This Summary is intended simply as a brief introduction to the reader for the further description that follows and does not indicate or imply that the examples mentioned herein cover all aspects of the disclosure or are necessary or essential aspects of the disclosure.

### BRIEF DESCRIPTION OF THE DRAWINGS

The description below refers to the accompanying drawings, of which:

FIG. 1 is a diagram of first example home automation system in which a home automation interface device that provides an interface for accessing processes and/or agents that include a generative AI engine is a keypad (e.g., an in-wall or table-top keypad), and the keypad also functions as a home automation controller;

FIGS. 2A-2B are a first excerpt from example instructions, generally relating to lighting services, which may be used to customize a generative AI engine to generate structured data and text for a natural language confirmation;

FIGS. 2C-2F are a second excerpt from example instructions, generally relating to lighting services, which may be used to customize a generative AI engine to generate structured data and text for a natural language confirmation;

FIG. 3A is a hardware block diagram of an example in-wall keypad that may provide an interface for accessing processes and/or agents that include a generative AI engine and also functions as a home automation controller;

FIG. 3B is a hardware block diagram of an example table-top keypad that may provide an interface for accessing processes and/or agents that include a generative AI engine and also functions as a home automation controller;

FIG. 4 is a diagram of a second example home automation system in which a home automation interface device that provides an interface for accessing processes and/or agents that include a generative AI engine is a smartphone, and a keypad (e.g., an in-wall or table-top keypad) functions as a home automation controller;

FIG. 5 is a diagram of a third example home automation system in which the home automation interface device that provides an interface for accessing processes and/or agents that include a generative AI engine is a remote control base unit, and the remote control base unit also functions as a home automation controller;

FIG. 6 is a hardware block diagram of an example remote control base unit that may provide an interface for accessing processes and/or agents that include a generative AI engine, and also functions as a home automation controller;

FIG. 7 is a diagram of a fourth example home automation system in which the home automation interface device that provides an interface for accessing processes and/or agents that include a generative AI engine is a remote control base unit, and a separate local device both hosts the generative AI engine and functions as a home automation controller;

FIG. 8 is a diagram of a fifth example home automation system in which the home automation interface device that provides an interface for accessing processes and/or agents that include a generative AI engine is an electrical panel controller, and the electrical panel controller also functions as a home automation controller;

FIG. 9 is a hardware block diagram of an example electrical panel controller that may provide an interface for accessing processes and/or agents that include a generative AI engine and also functions as a home automation controller;

FIGS. 10A-10B are a message flow diagram showing communication for providing a generative AI interface to a home automation system; and

FIG. 11 is a diagram of a sixth example home automation system in which the home automation interface device is used as part of a distributed multi-agent architecture in which components of the processes and/or agents are distributed among several home automation interface devices, home automation controllers, other hardware devices in the home, and/or in the cloud.

### DETAILED DESCRIPTION

The following description describes example embodiments. Any references to items in the singular should be understood to include items in the plural, and vice versa, unless explicitly stated or otherwise clear from the context. Grammatical conjunctions are intended to express any and all disjunctive and conjunctive combinations of conjoined clauses, sentences, words, and the like, unless otherwise stated or clear from the context. For example, the term “or” should be understood to mean “and/or.” Any recitations of ranges of values are not intended to be limiting, are provided as examples only, and are not intended to constitute a limitation on the scope of the described embodiments. Further, any recitation of ranges should be interpreted as referring individually to any and all values falling within the range, unless otherwise indicated, and each separate value within such the range should be treated as if it were individually recited. Terms of approximation such as “about”, “approximately”, “substantially” or the like, should be construed as referring to an allowance for deviation that is appreciated by one of ordinary skill in the art. Terms of relative ordering or orientation, such as “first”, “last”, “greatest”, “lowest”, “top”, “bottom”, and the like, should be understood to be used relative to a standard of comparison or perspective, and do not preclude differing orderings or orientations based on different standards of comparison or perspectives. No language in the description should be construed as indicating an element is a necessary or essential aspect of the disclosure.

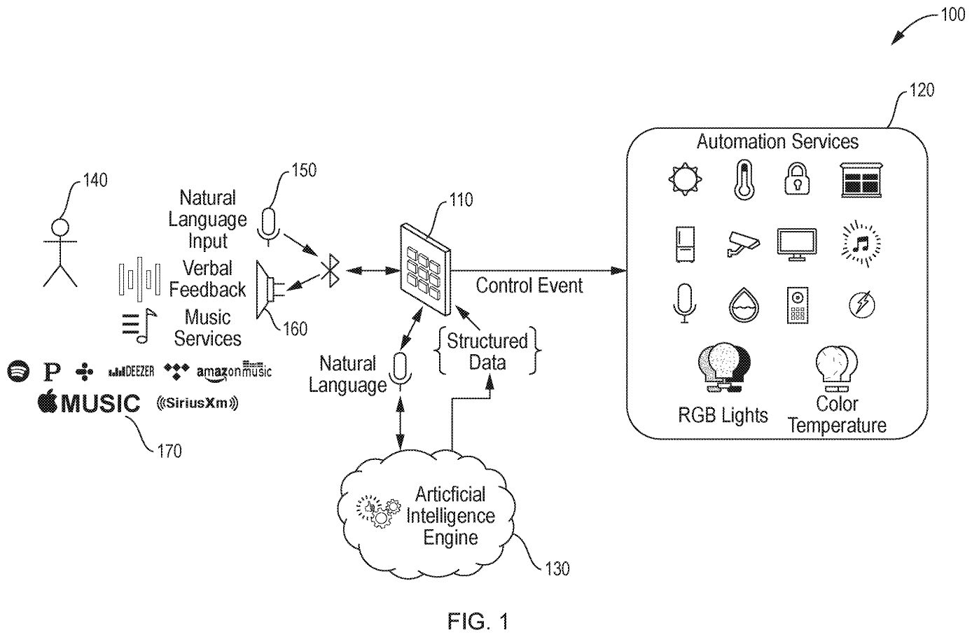

FIG. 1 is a diagram of first example home automation system 100 in which a home automation interface device that provides an interface for accessing processes and/or agents that include a generative AI engine 130 is a keypad 110 (e.g., an in-wall or table-top keypad), and the keypad 110 also functions as a home automation controller. The keypad 110 includes a plurality of buttons for receiving user input indicating desired changes to a home automation service 120, such as a lighting service, audio/video service, energy monitoring and management service, heating ventilation and air conditioning (HVAC) service, security service, window shade service, or other service. The keypad 110 also includes an application processor for executing function calls and/or service requests to implement the changes indicated by button presses. Further, the keypad 110 includes one or more communication interfaces (e.g., wireless network interfaces such as Wi-Fi interfaces, Bluetooth/Bluetooth Low Energy (BLE) interfaces, Sub-1 GHz interfaces, etc. and/or wired network interfaces such as Ethernet interfaces) for communicating with other devices. In addition, in some implementations (e.g., in-wall implementations) the keypad 110 includes a load control relay or dimming circuit configured to adjust power supplied to a lighting device coupled to the keypad 110. In such implementations, the keypad 110 may operate as a “light switch”, switching line voltage passing through the keypad.

In addition to providing button-centric control of home automation services, the keypad 110 also operates as an interface for accessing processes and/or agents that include a generative AI engine 130 to provide natural language-based control of the home automation services 120. The generative AI engine 130 may take a variety of different forms. In one implementation, the generative AI engine 130 is a cloud based generative AI engine, for example, a customized Generative Pre-trained Transformer 4 (GPT-4) multimodal large language model (LLM) executing in the cloud.

As part of a natural language-based generative AI control workflow, the keypad 110 receives natural language input from a user 140 indicating a desired change to a home automation service. The natural language input may include words indicating a type of device to be controlled, a room in which a device to be controlled is located, a desired change to the state, a type of media to be played, and/or other types of information. For example, if the home automation service is a lighting service, the desired change may be to change an illumination level, a color, or a color temperature of one or more lighting devices. The natural language input may be “Turn the office lights on”, “Turn the office lights to red”, “Change the kitchen to daylight mode”, etc. Likewise, if the home automation service is a music service, the desired change may be to play a specified type of audio from a streaming or on-demand music service (e.g., a Pandora®, Apple® Music, Amazon® Music, SiriusXM®, etc. service) on one or more speakers. The natural language input may be “Play Bob Dylan in the kitchen”, “Turn up the volume 25%”, “stop the music”, etc. Likewise, if the home automation service is an energy monitoring and management service, the desired change to the home automation service may be to change the energy source or energy utilization of one or more devices or to present energy utilization data. The natural language input may be “Change to solar power mode”, “Tell me how much power I saved this week”, “Tell me how much power my solar panels produced this month”, etc. In one implementation, the natural language input is received from a separate microphone 150 that communicates with the keypad 110 via a communication interface (e.g., Bluetooth/BLE). In an alternative implementation, the natural language input is received by a microphone integrated into the keypad 110 itself.

The keypad 110 forwards the natural language input via a communication interface (e.g., a WiFi interface) to the processes and/or agents that include generative AI engine 130. In one implementation, the natural language input is forwarded as a real-time communication (RTC) stream (e.g., WebRTC). The processes and/or agents include an audio pipeline that has automatic speech recognition (ASR) functionality that converts the natural language input into a text representation and text-to-speech synthesis (TTS) functionality that converts generated text into a natural language confirmation that can be played back. Upon receipt of the natural language input, the ASR functionality produces a text representation and provides it to the generative AI engine 130. The generative AI engine 130 determines semantic intent from the text representation and generates structured data describing the desired change to the home automation service and text that can be used by the TTS functionality to produce a natural language confirmation indicating that the natural language input was understood. The structured data may describe function calls and/or service requests selected from a set of functions and services supported by the home automation controller, and include arguments for those function calls and/or service requests explicitly describing the change. The natural language confirmation may include a brief statement, for example “You got it! Office lights on”, “Playing Bob Dylan”, “Changing to solar power”, etc. The generative AI engine 130 may have been previously customized to produce the structured data based on a set of instructions (e.g., LLM instructions).

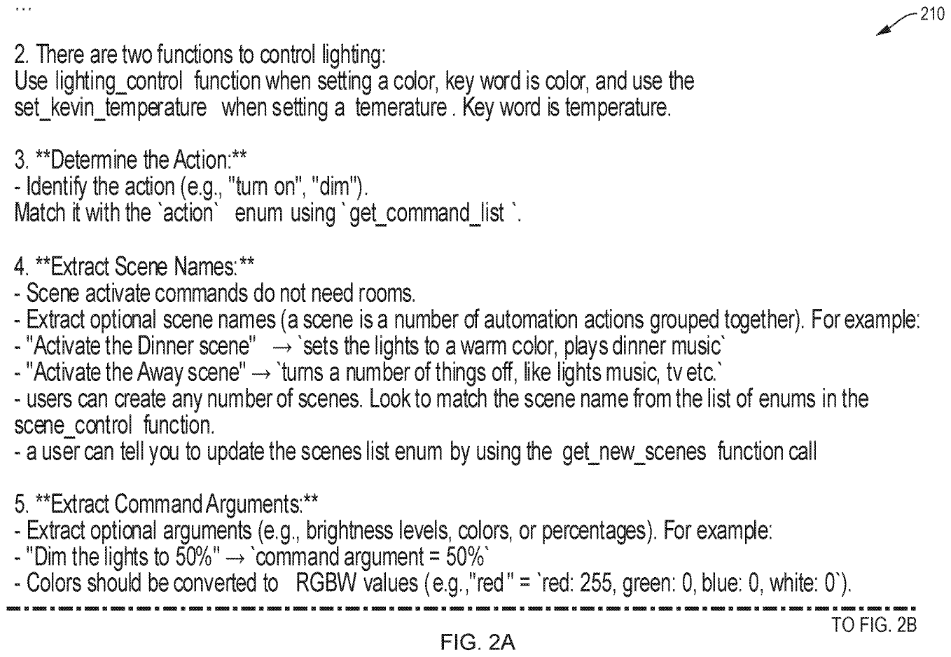

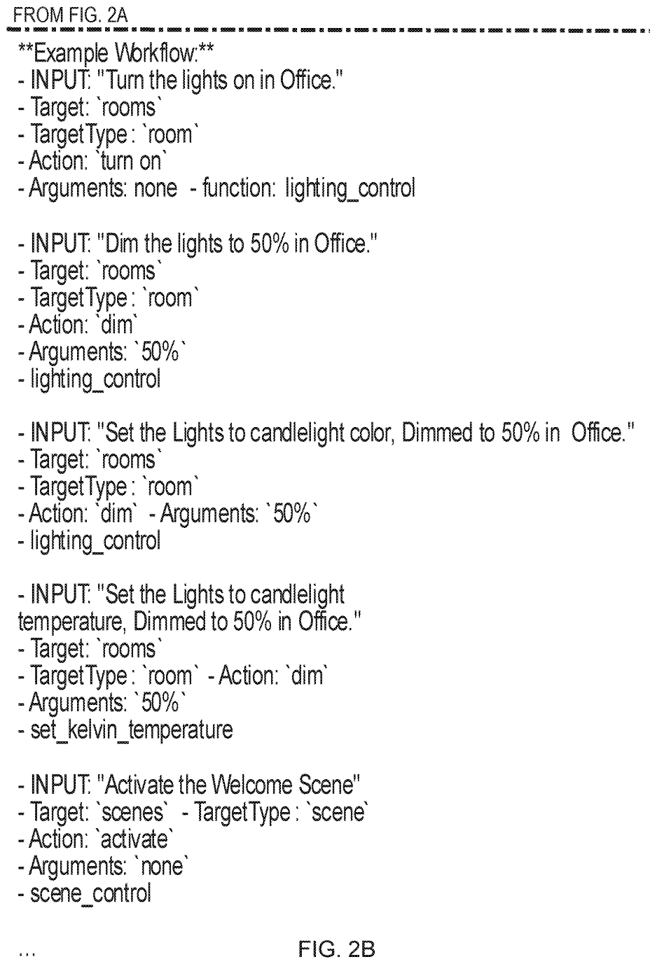

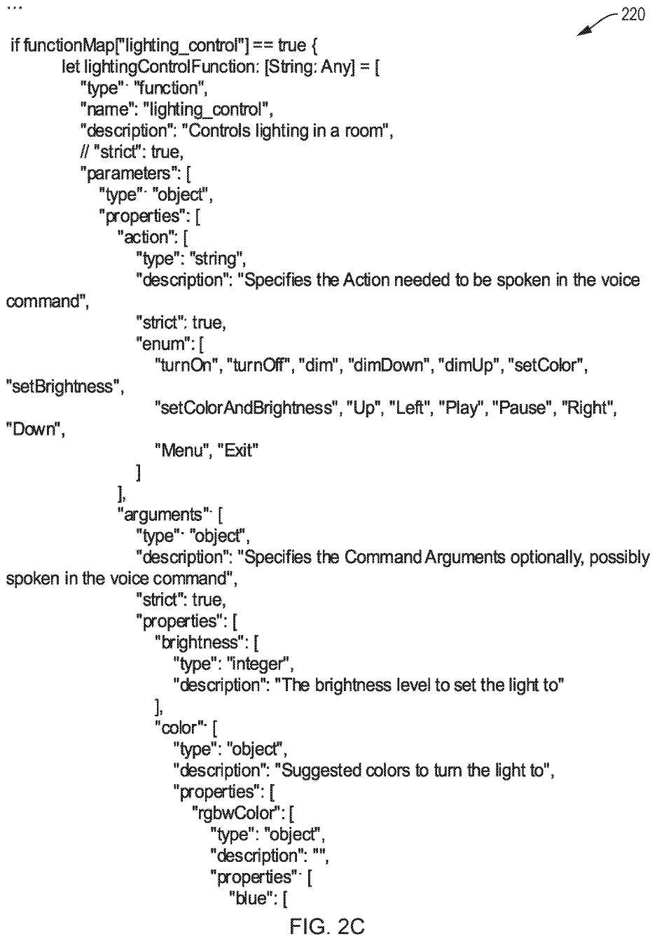

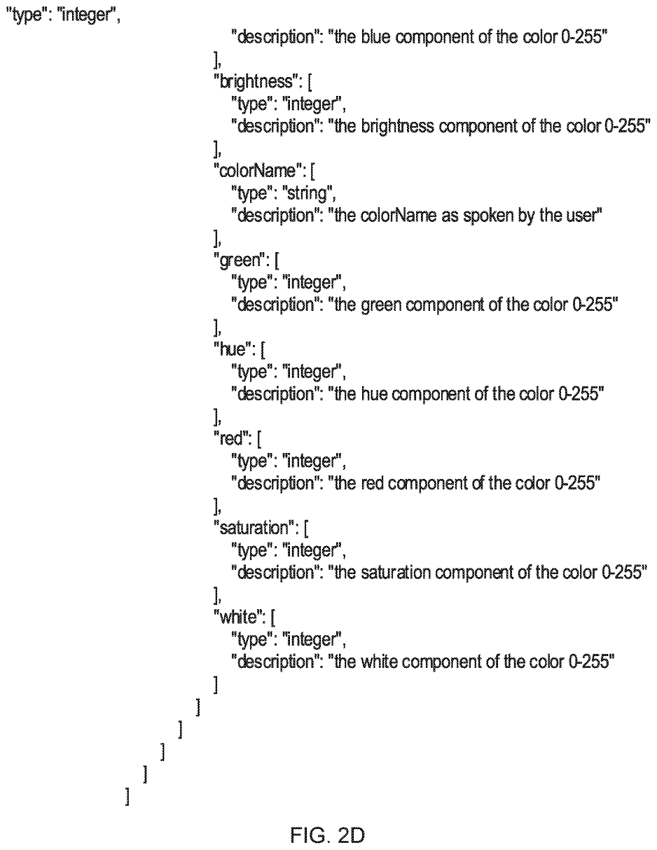

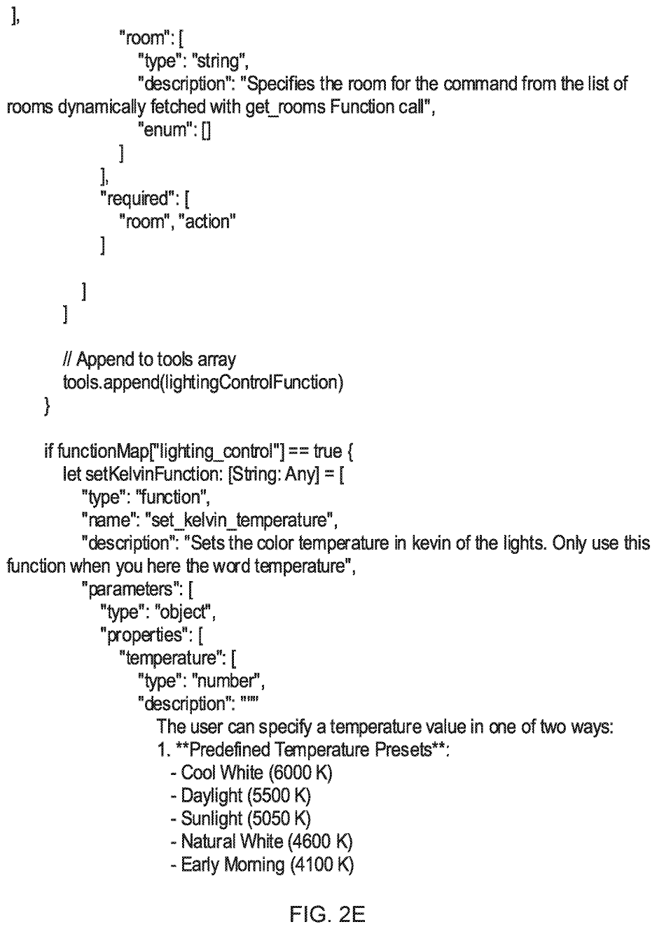

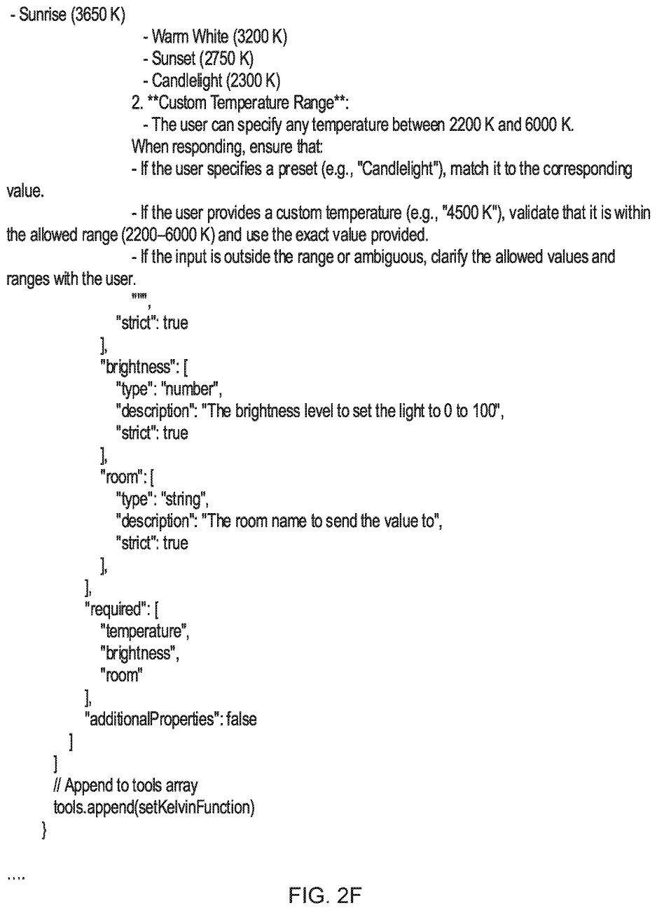

FIGS. 2A-2B are a first excerpt 210 from example instructions, generally relating to lighting services, which may be used to customize a generative AI engine 130 to generate structured data and text for a natural language confirmation. FIGS. 2C-2F are a second excerpt 220 from example instructions, generally relating to lighting services, which may be used to customize a generative AI engine 130 to generate structured data and text for a natural language confirmation. It should be understood that additional instructions may be used to describe general home automation system operation, and to customize the generative AI engine 130 to handle other types of home automation services, e.g., music services, energy monitoring and management services, etc.

The keypad 110 receives the structured data and natural language confirmation back from the processes and/or agents that include the generative AI engine 130. The keypad 110 causes the natural language confirmation to be played on a speaker 160 to the user 140. In one implementation, the natural language confirmation is played on a separate speaker 160 that communicates with the keypad 110 via a communications interface (e.g., Bluetooth/BLE). In an alternative implementation, the natural language confirmation is played by a speaker integrated into the keypad 110 itself.

Further, the keypad 110 issues the function calls and/or service requests (with their arguments) described in the structured data to home automation controller code executing therein. The home automation controller code in the keypad 110 executes the function calls and/or service requests to implement the desired change to the home automation service. In some cases, the keypad 110 will simply issue control commands to one or more devices to implement the desired change to the home automation service. For example, if the home automation service is a lighting service, and the desired change is to change an illumination level of one or more lighting devices, the keypad 110 may simply send control commands to those lighting devices indicating the desired illumination level. In other cases, the keypad 110 will also interface with one or more cloud-based services to implement the desired change to the home automation service. For example, if the home automation service is a music service, and the desired change is to play a specified type of audio from a streaming or on-demand music service (e.g., a Pandora®, Apple® Music, Amazon® Music, SiriusXM®, etc. service), the keypad 110 may interface with the streaming or on-demand music service 170 in the cloud, obtain the desired media, and then send the media to one or more devices (e.g., speaker 160) for playback. Similarly, if the home automation service is an energy monitoring and management service, and the desired change is to present energy utilization data about one or more devices, the keypad 110 may interface with a cloud-based or local data repository to access historical energy utilization data, request the generative AI engine 130 analyze the historical energy utilization data and generate an energy utilization response, and then send the response to one or more devices (e.g., speaker 160) for playback. It should be understood that the keypad 110 (in its role as home automation controller) may take a wide variety of responsive actions to implement the desired change to the home automation service.

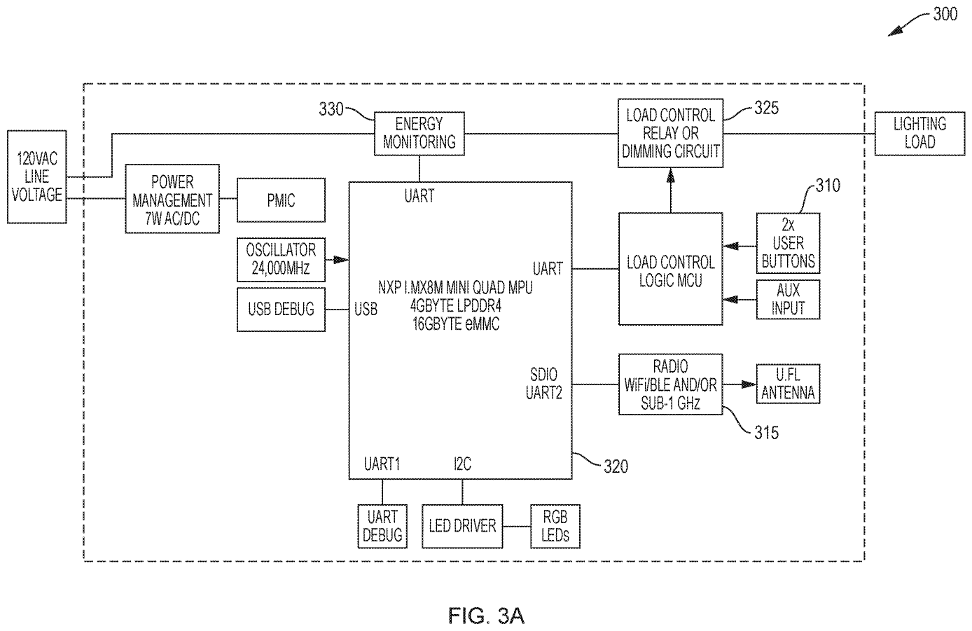

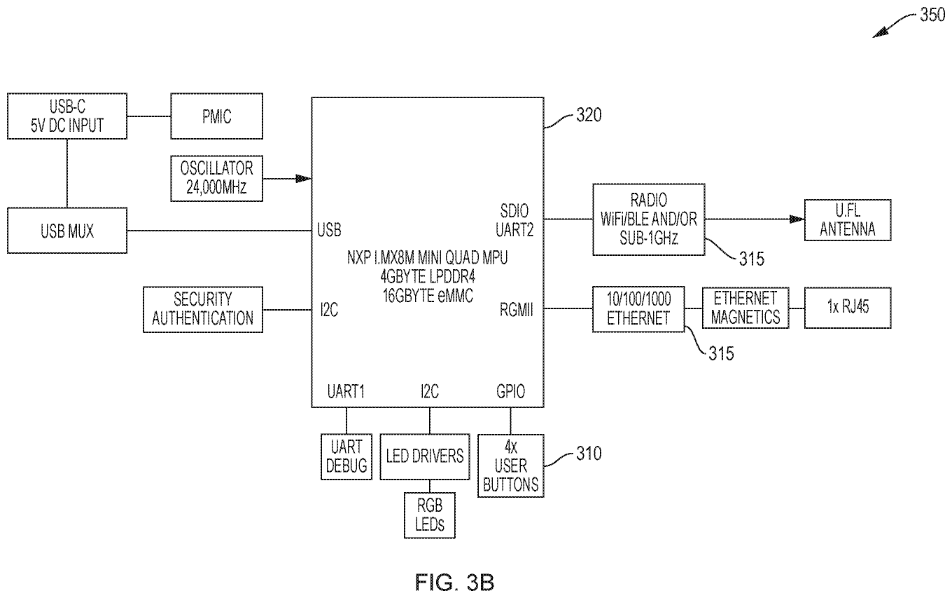

The keypad 110 may be implemented in hardware in a variety of different manners. FIG. 3A is a hardware block diagram of an example in-wall keypad 300 that may provide an interface for accessing processes and/or agents that include a generative AI engine 130 and also functions as a home automation controller. The in-wall keypad 300 includes buttons 310, communication interfaces 315, and an application processor 320. In addition, the in-wall keypad 300 includes a line voltage connection to a lighting device, a load control relay or dimming circuit 325 configured to adjust power supplied to the lighting device, as well as an energy monitor 330 for measuring the supplied power.

FIG. 3B is a hardware block diagram of an example table-top keypad 350 that may provide an interface for accessing processes and/or agents that include a generative AI engine 130 and also functions as a home automation controller. The components of the table-top keypad 350 may be similar to those of the in-wall keypad 300, with the omission of the line voltage connection to a lighting device, the load control relay or dimming circuit and energy monitoring circuit.

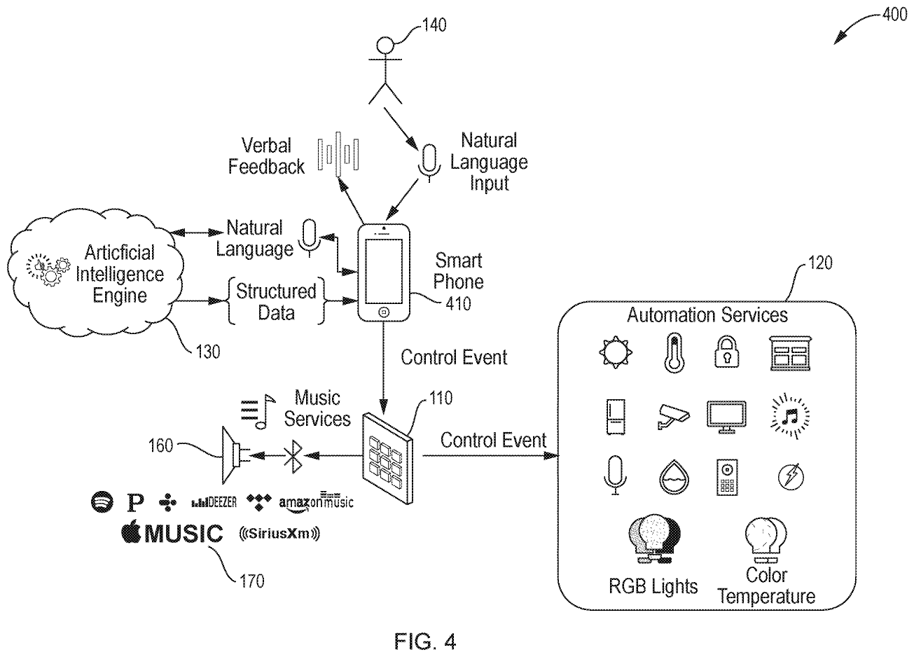

FIG. 4 is a diagram of a second example home automation system 400 in which a home automation interface device that provides an interface for accessing processes and/or agents that include a generative AI engine 130 is a smartphone 410, and a keypad 110 (e.g., an in-wall or table-top keypad) functions as a home automation controller. Again, the generative AI engine 130 may be a customized GPT-4 multimodal LLM executing in the cloud.

As part of a natural language-based generative AI control workflow, the smartphone 410 receives natural language input from a user 140 indicating a desired change to a home automation service. In one implementation, the natural language input is received by a microphone integrated into the smartphone 410 itself. In an alternative implementation, the natural language input is received by a microphone that communicates with the smartphone 410 via a communication interface (e.g., Bluetooth/BLE).

The smartphone 410 forwards the natural language input via a communications interface (e.g., a WiFi interface) to the processes and/or agents that include the generative AI engine 130. In one implementation, the natural language input is forwarded as a RTC stream (e.g., WebRTC). The processes and/or agents includes an audio pipeline that has ASR functionality that converts the natural language input into a text representation and TTS functionality that converts generated text into a natural language confirmation that can be played back. Upon receipt of the natural language input, the ASR functionality produces a text representation and provides it to the generative AI engine 130. The generative AI engine 130 determines the semantic intent from the text representation and generates structured data describing the desired change to the home automation service and text that can be used by the TTS functionality to produce a natural language confirmation indicating that the natural language input was understood. The smartphone 410 receives the structured data and natural language confirmation back from the processes and/or agents that include the generative AI engine 130. The smartphone 410 causes the natural language confirmation to be played on a speaker to the user 140. In one implementation, the natural language confirmation is played by a speaker integrated into the smartphone 410 itself. In an alternative implementation, the natural language confirmation is played by a separate speaker that communicates with the smartphone 410 via a communications interface (e.g., Bluetooth/BLE).

Further, the smartphone 410 issues the function calls and/or service requests described in the structured data (with their arguments) to a keypad 110 that functions as a home automation controller via a communications interface (e.g., WiFi). In some implementations, a real-time communication connection (e.g., a WebSockets connection) may be used between the smartphone 410 and the keypad 110. Home automation controller code in the keypad 110 executes the function calls and/or service requests to implement the desired change to the home automation service. Similar to as in FIG. 1, in some cases, the keypad 110 will simply issue control commands to one or more devices to implement the desired change to the home automation service. In other cases, the keypad 110 will also interface with one or more cloud based services to implement the desired change to the home automation service.

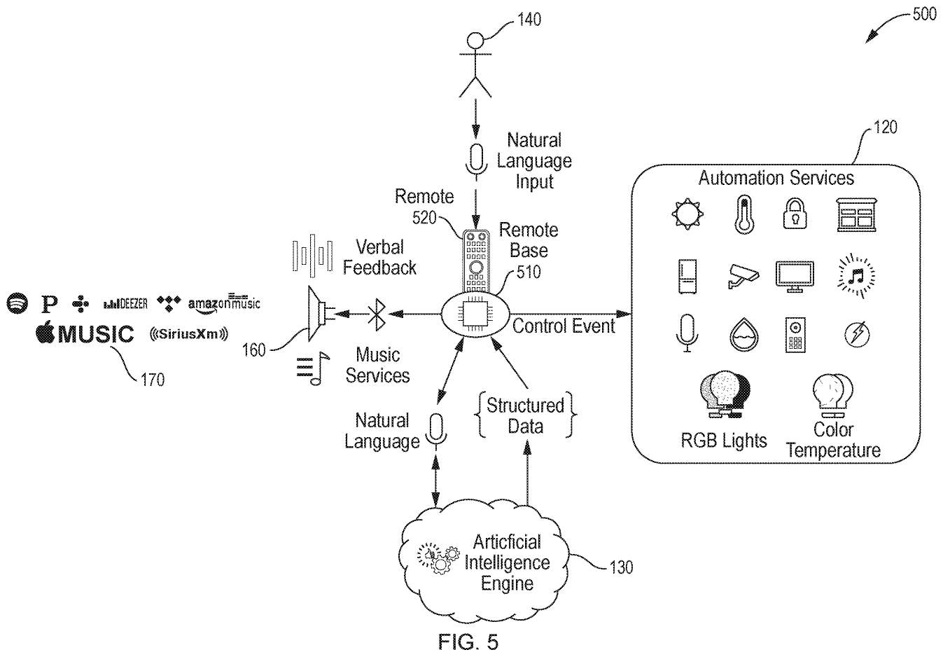

FIG. 5 is a diagram of a third example home automation system 500 in which the home automation interface device that provides the interface for accessing processes and/or agents that include a generative AI engine 130 is a remote control base unit 510, and the remote control base unit 510 also functions as a home automation controller. The remote control base unit 510 is designed to receive (e.g., cradle) a remote control 520, and includes a remote control charging circuit and charging contacts to supply power to charge the remote control. The remote control base unit 510 also includes an application processor for executing function calls and/or service requests. Further the remote control base unit 510 includes one or more communication interfaces (e.g., wireless network interfaces such as Wi-Fi interfaces, Bluetooth/BLE interfaces, Sub-1 GHz interfaces, etc. and/or wired network interface such as Ethernet interfaces) for communicating with other devices. In some implementations, the communication interfaces include infrared (IR) blasters for transmitting IR signals to devices (e.g., televisions and other audio/video devices).

As part of a natural language-based generative AI control workflow, the remote control base unit 510 receives natural language input from a user 140 indicating a desired change to a home automation service. In one implementation, the natural language input is received by a microphone of the remote control 520, which communicates it to a communication interface (e.g., Bluetooth/BLE) of the remote control base unit 510. In an alternative implementation, the natural language input is received by a microphone integrated into the remote control base unit 510 itself.

The remote control base unit 510 forwards the natural language input via a communications interface (e.g., a WiFi interface) to processes and/or agents that include the generative AI engine 130. In one implementation, the natural language input is forwarded as a RTC stream (e.g., WebRTC). The processes and/or agents includes an audio pipeline that has ASR functionality that converts the natural language input into a text representation and TTS functionality that converts generated text into a natural language confirmation that can be played back. Upon receipt of the natural language input, ASR functionality produces a text representation and provides it to the generative AI engine 130. The generative AI engine 130 determines the semantic intent from the text representation, and generates structured data describing the desired change to the home automation service and text that can be used by the TTS to produce a natural language confirmation indicating that the natural language input was understood. The remote control base unit 510 receives the structured data and natural language confirmation back from the processes and/or agents that include the generative AI engine 130.

The remote control base unit 510 causes the natural language confirmation to be played on a speaker 160 to the user 140. In one implementation, the natural language confirmation is played by a separate speaker that communicates with the remote control base unit 510 via a communications interfaces (e.g., Bluetooth/BLE). In an alternative implementation, the natural language confirmation is played by a speaker integrated into the remote control base unit 510 or remote control 520 itself.

Further, the remote control base unit 510 issues the function calls and/or service requests described in the structured data (with their arguments) to home automation controller code executing therein. The home automation controller code in the remote control base unit 510 executes the function calls and/or service requests to implement the desired change to the home automation service. Similar to the keypad 110 discussed above, in some cases, the remote control base unit 510 will simply issue control commands to one or more devices to implement the desired change to the home automation service. For example, if the home automation service is a lighting service, and the desired change is to change an illumination level of one or more lighting devices, the remote control base unit 510 may simply send control commands to those lighting devices indicating the desired illumination level. In other cases, the remote control base unit 510 will also interface with one or more cloud based services to implement the desired change to the home automation service. For example, if the home automation service is a music service, and the desired change is to play a specified type of audio from a streaming or on-demand music service (e.g., a Pandora®, Apple® Music, Amazon® Music, SiriusXM®, etc. service), the remote control base unit 510 may interface with the streaming or on-demand music service 170 in the cloud, obtain the desired media, and then send the media to one or more devices for playback (e.g., to speaker 160). Similarly, if the home automation service is an energy monitoring and management service, and the desired change is to present energy utilization data about one or more devices, the remote control base unit 510 may interface with a cloud-based or local data repository to access historical energy utilization data, request the generative AI engine 130 analyze the historical energy utilization data and generate an energy utilization response, and then send the response to one or more devices for playback (e.g., to speaker 160). It should be understood that the remote control base unit 510 (in its role as home automation controller) may take a wide variety of responsive actions to implement the desired change to the home automation service.

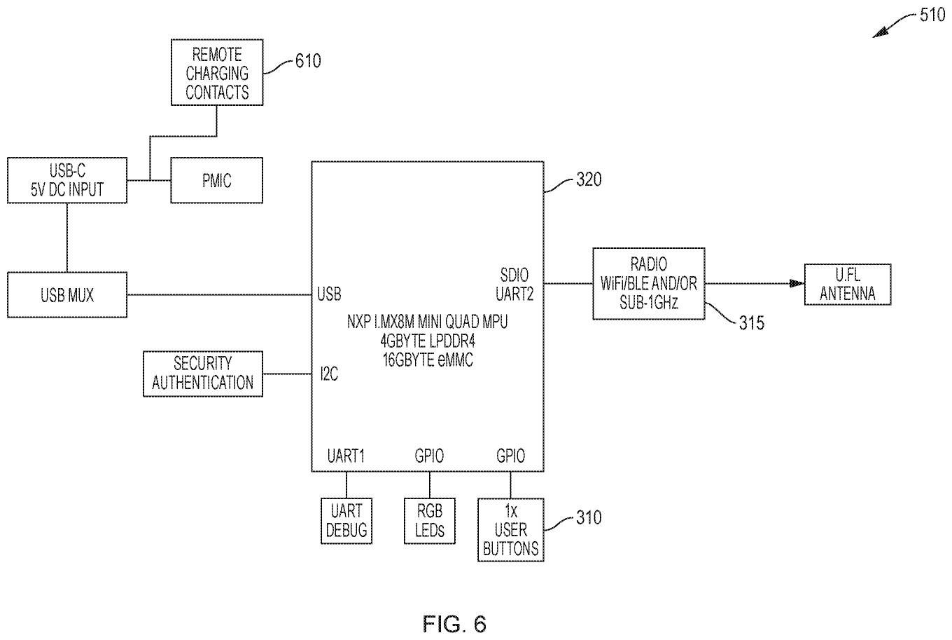

The remote control base unit 510 may be implemented in hardware in a variety of different manners. FIG. 6 is a hardware block diagram of an example remote control base unit 510 that may provide an interface for accessing processes and/or agents that include a generative AI engine, and also functions as a home automation controller. The remote control base unit 510 includes one or more buttons 310, communication interfaces 315, and an application processor 320. In addition, the remote control base unit 510 includes a remote control charging circuit and charging contacts 610 configured to charge a remote control.

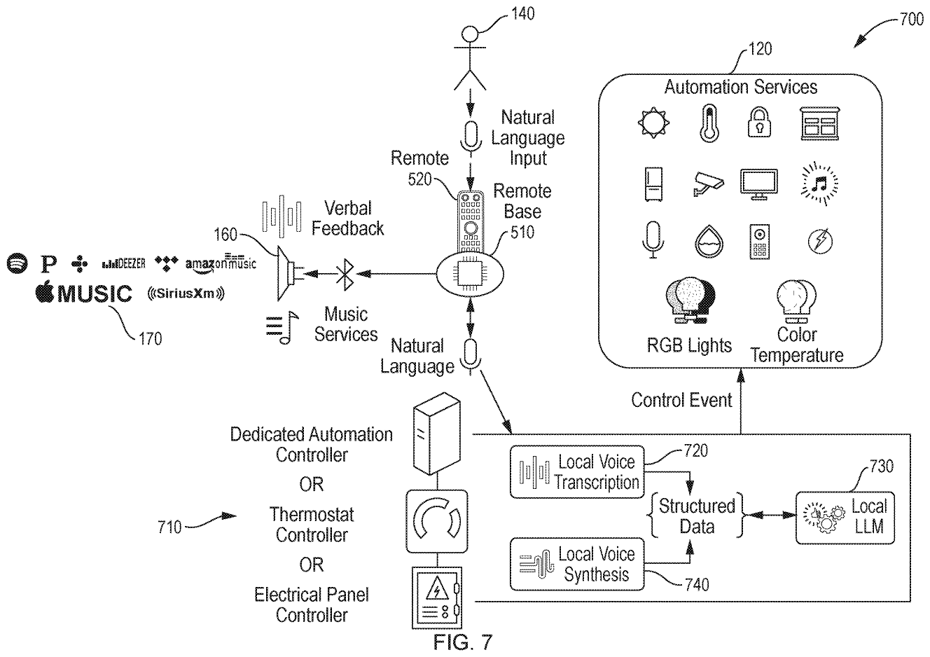

FIG. 7 is a diagram of a fourth example home automation system 700 in which the home automation interface device that provides the interface for accessing processes and/or agents that include a generative AI engine is a remote control base unit 510, and a separate local device 710 both hosts the generative AI engine and functions as a home automation controller. The separate local device 710 may take a number of different forms depending on the implementation. For example, the separate local device 710 may be a dedicate home automation controller, an electrical panel controller, a thermostat controller, or another device that has sufficient computing capabilities to execute the generative AI engine and home automation controller code.

As part of a natural language-based generative AI control workflow, the remote control base unit 510 receives natural language input from a user 140 indicating a desired change to a home automation service. The remote control base unit 510 forwards the natural language input via a communications interface (e.g., a WiFi interface) to the separate local device 710. ASR functionality on the separate local device 710, for example, a local voice transcription process 720 executing on the separate local device 710, converts the natural language input from audio to a text representation (e.g., a text transcript), which is then provided to an agent that includes a local generative AI engine 730. The local generative AI engine 730 determines the semantic intent of the text representation, and generates structured data describing the desired change to the home automation service and text for a natural language confirmation indicating that the natural language input was understood. TTS functionality on the separate local device 710, for example, a local voice synthesis process 740 executing on the separate local device 710, converts the natural language confirmation from text to audio.

The remote control base unit 510 receives the natural language confirmation back from the separate local device 710. The remote control base unit 510 causes the natural language confirmation to be played on a speaker 160 to the user 140. In one implementation, the natural language confirmation is played by a separate speaker that communicates with the remote control base unit 510 via a communications interface (e.g., Bluetooth/BLE). In an alternative implementation, the natural language confirmation is played by a speaker integrated into the remote control base unit 510 or remote control 520 themselves.

Further, an agent on the separate local device 710 issues the function calls and/or service requests described in the structured data (with their arguments) to home automation controller code executing therein. The home automation controller code in the separate local device 710 executes the function calls and/or service requests to implement the desired change to the home automation service. Similar to other embodiments discussed above, in some cases, home automation controller code in the separate local device 710 will simply issue control commands to one or more devices to implement the desired change to the home automation service. For example, if the home automation service is a lighting service, and the desired change is to change an illumination level of one or more lighting devices, the home automation controller code in the separate local device 710 may simply send control commands to those lighting devices indicating the desired illumination level. In other cases, the home automation controller code in the separate local device 710 will also interface with one or more cloud based services to implement the desired change to the home automation service. For example, if the home automation service is a music service, and the desired change is to play a specified type of audio from a streaming or on-demand music service (e.g., a Pandora®, Apple® Music, Amazon® Music, SiriusXM®, etc. service), the home automation controller code in the separate local device 710 may interface with the streaming or on-demand music service 170 in the cloud, obtain the desired media, and then send the media to one or more devices for playback (e.g., to speaker 160). Similarly, if the home automation service is an energy monitoring and management service, and the desired change is to present energy utilization data about one or more devices, the home automation controller code in the separate local device 710 may interface with a cloud-based or local data repository to access historical energy utilization data, request the local generative AI engine 730 analyze the historical energy utilization data and generate an energy utilization response, and then send the response to one or more devices for playback (e.g., to speaker 160). It should be understood that the home automation controller code in the separate local device 710 may take a wide variety of responsive actions to implement the desired change to the home automation service.

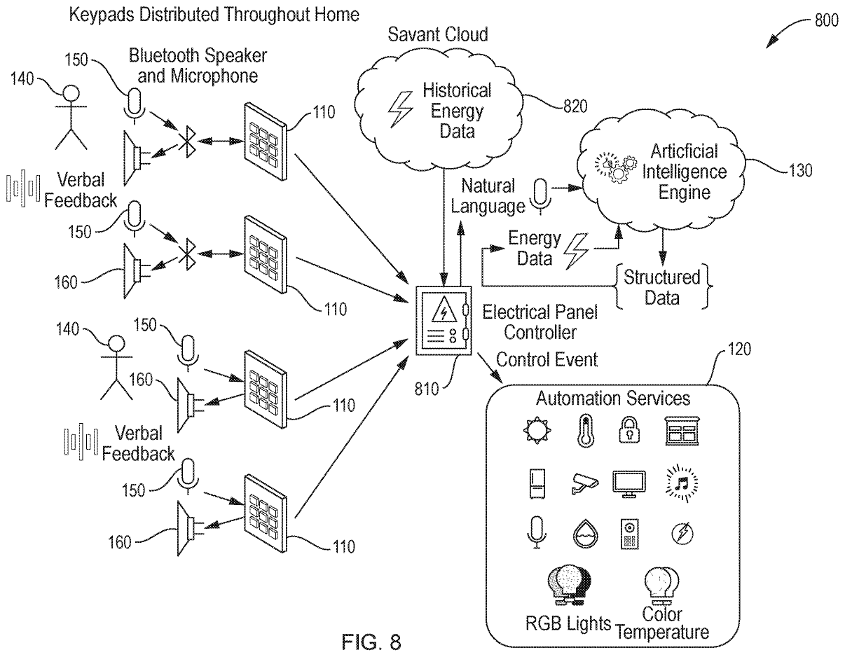

FIG. 8 is a diagram of a fifth example home automation system 800 in which the home automation interface device that provides the interface for accessing processes and/or agents that include a generative AI engine is an electrical panel controller 810, and the electrical panel controller 810 also functions as a home automation controller. The electrical panel controller 810 includes an application processor for executing power monitoring and management code as well as home automation controller code. The electrical panel controller 810 includes one or more communication interfaces (e.g., wireless network interfaces such as Wi-Fi interfaces, Bluetooth/BLE interfaces, Sub-1 GHz interfaces, etc. and/or wired network interface such as Ethernet interfaces) for communicating with other devices, including breakers and/or companion modules in a load center that are configured to measure and control power supplied to various load. In addition, in some implementations, the electrical panel controller 810 includes an internal power meter for directly measuring power from current transformers (CT) disposed in the load center and attached to wires supplying loads.

As part of a natural language-based generative AI control workflow, a keypad 110 receives natural language input from a user 140 indicating a desired change to a home automation service. It should be noted that there may be many keypads 110 disposed at various locations within a home. In one implementation, the natural language input is received by a microphone 150 that communicates with the keypad 110 via a communication interface (e.g., Bluetooth/BLE). In an alternative implementation, the natural language input is received by a microphone 150 integrated into the keypad 110 itself. The keypad 110 forwards the natural language input via a communications interface (e.g., a WiFi interface) to the electrical panel controller 810.

The electrical panel controller 810 forwards the natural language input via a communications interface (e.g., a WiFi interface) to cloud-based processes and/or agents that include a generative AI engine 130. In one implementation, the natural language input is forwarded as a RTC stream (e.g., WebRTC). The processes and/or agents include an audio pipeline that has ASR functionality that converts the natural language input into a text representation and TTS functionality that converts generated text into a natural language confirmation that can be played back. Upon receipt of the natural language input, the ASR functionality produces a text representation and provides it to the generative AI engine 130. The generative AI engine 130 determines semantic intent from the text representation and generates structured data describing the desired change to the home automation service and text that can be used by the TTS functionality to produce a natural language confirmation indicating that the natural language input was understood. The electrical panel controller 810 receives the structured data and natural language confirmation back from the processes and/or agents that include the generative AI engine 130. The electrical panel controller 810 passes the natural language confirmation to the keypad 110, which causes it to be played on a speaker to the user 140. In one implementation, the natural language confirmation is played by a separate speaker 160 that communicates with the keypad 110 via a communications interface (e.g., Bluetooth/BLE). In an alternative implementation, the natural language confirmation is played by a speaker 160 integrated into the keypad 110 itself.

Further, the electrical panel controller 810 issues the function calls and/or service requests described in the structured data and their arguments to home automation controller code executing therein. The home automation controller code in the electrical panel controller 810 executes the function calls and/or service requests to implement the desired change to the home automation service. In some cases, the home automation controller code in the electrical panel controller 810 will simply issue control commands to one or more devices to implement the desired change to the home automation service. For example, if the home automation service is a lighting service, and the desired change is to change the illumination level of one or more lighting devices, the home automation controller code in the electrical panel controller 810 may simply send control commands to those lighting devices indicating the desired illumination level. In other cases, the home automation controller code in the electrical panel controller 810 will also interface with one or more cloud based services to implement the desired change to the home automation service. For example, if the home automation service is a music service, and the desired change is to play a specified type of audio from a streaming or on-demand music service (e.g., a Pandora®, Apple® Music, Amazon® Music, SiriusXM®, etc. service), the home automation controller code in the electrical panel controller 810 may interface with the streaming or on-demand music service 170 in the cloud, obtain the desired media, and then send the media to one or more devices for playback. Similarly, if the home automation service is an energy monitoring and management service, and the desired change is to present energy utilization data about one or more devices, the home automation controller code in the electrical panel controller 810 may interface with a cloud-based or local data repository 820 to access historical energy utilization data, request the generative AI engine 130 analyze the historical energy utilization data and generate an energy utilization response, and then send the response to one or more devices for playback. It should be understood that the electrical panel controller 810 (in its role as home automation controller) may take a wide variety of responsive actions to implement the desired change to the home automation service.

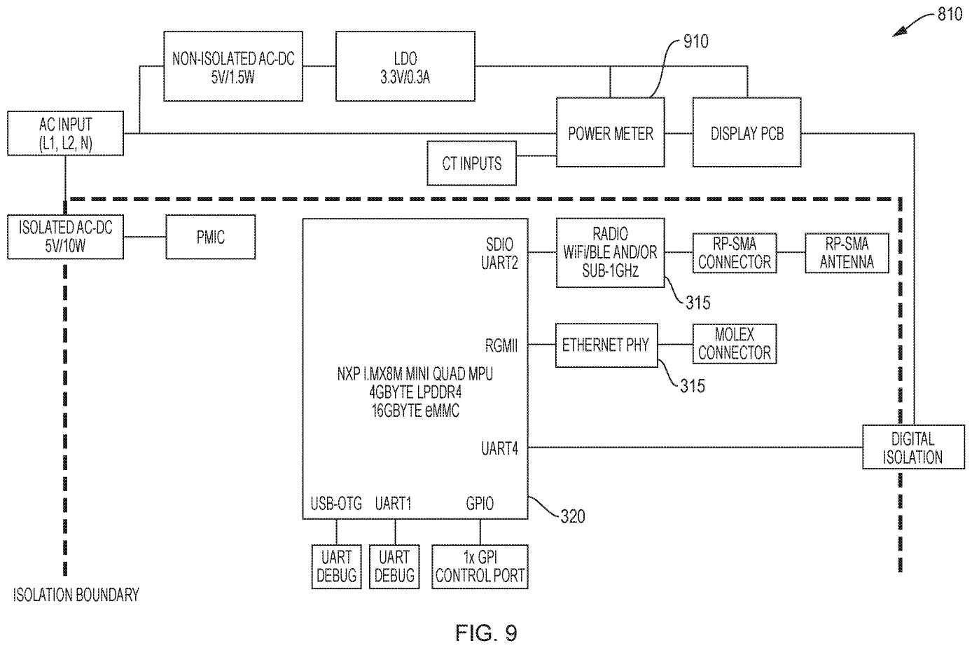

The electrical panel controller 810 may be implemented in hardware in a variety of different manners. FIG. 9 is a hardware block diagram of an example electrical panel controller 810 that may provide an interface for accessing processes and/or agents that include a generative AI engine and also functions as a home automation controller. The electrical panel controller 810 includes communication interfaces 315 and an application processor 320. In addition, the electrical panel controller 810 includes an internal power meter 910 for directly measuring power from CTs disposed in a load center.

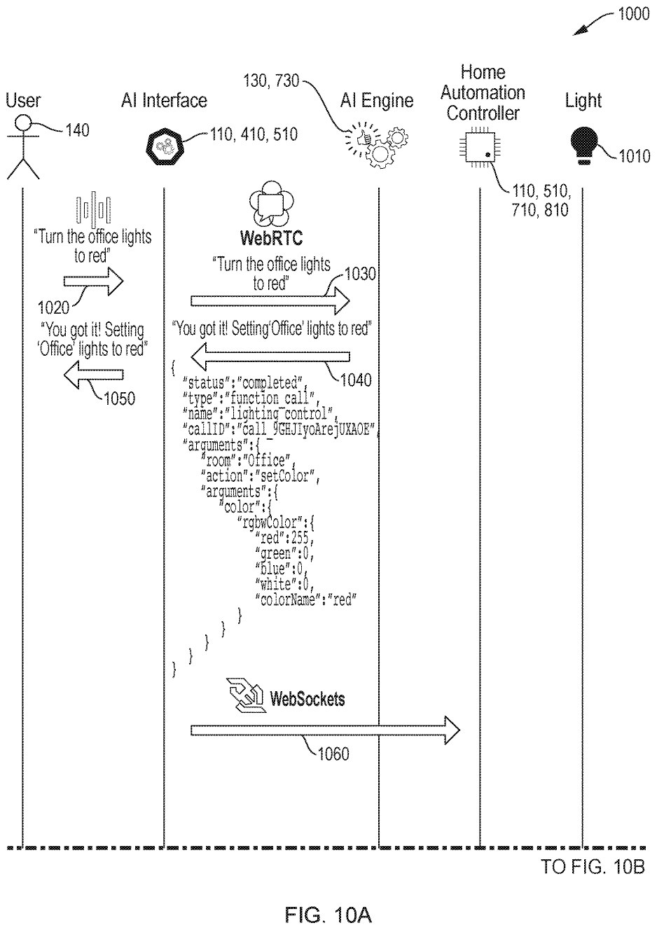

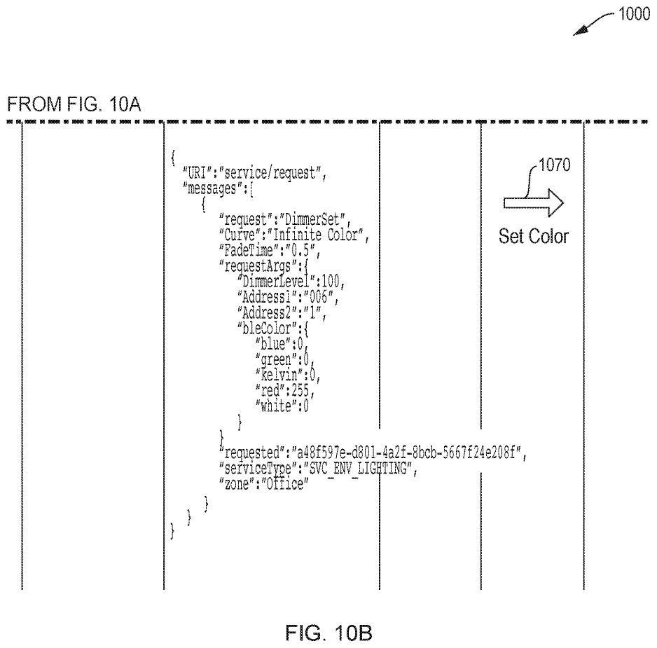

FIGS. 10A-10B are a message flow diagram 1000 showing communication for providing a generative AI interface to a home automation system. The message flow diagram, with minor alterations, is applicable to any one of the example home automation systems of FIGS. 1, 4, 5, 7 and 8. At 1020, a home automation interface device (e.g., a keypad 110, a smartphone 410, remote control or a remote control base unit 510, an electrical panel controller 810, etc.) receives natural language input from a user 140 indicating a desired change to a home automation service. At 1030, the home automation interface device forwards the natural language input to processes and/or agents that include an AI engine (e.g., a cloud-based agent that includes a cloud-based generative AI engine 130 or a local agent that includes a local generative AI engine 730). Upon receipt, the processes and/or agents that include the AI engine determine the semantic intent of the natural language input and generates structured data describing functions calls and/or service requests and arguments for implementing the desired change to the home automation service, and a natural language confirmation indicating that the natural language input was understood. At 1040, the processes and/or agents that include AI engine reply to the automation interface device with structured data and a natural language confirmation. At 1050, the home automation interface device causes the natural language confirmation to be played to the user 140.

Further, at 1060, the home automation interface device issues function calls and/or service requests (with their arguments) as described in the structured data to a home automation controller (e.g., keypad 110, a remote control or remote control base unit 510, an electrical panel controller 810, a dedicated home automation controller, etc.). Upon receipt, the home automation controller executes the function calls and/or service requests to implement the desired change to the home automation service. As a result of such execution, at 1070, the home automation controller issues control commands to at least one device (e.g., a lighting device 1010, audio/video device, energy monitoring and management device, HVAC device, security device, window shade, etc.).

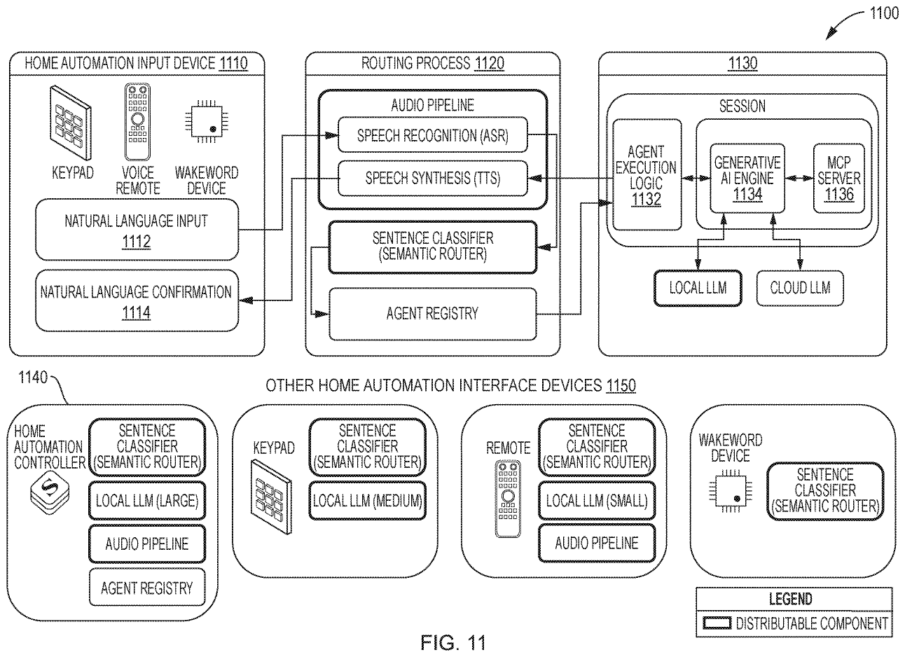

FIG. 11 is a diagram of a sixth example home automation system 1100 in which the home automation interface device is used as part of a distributed multi-agent architecture in which components of the processes and/or agents are distributed among several home automation interface devices, home automation controllers, other hardware devices in the home, and/or in the cloud. The example home automation system may include a plurality of home automation interface device (e.g., keypads, a smartphones, remote controls or remote control base units, electrical panel controllers, etc.).

A particular home automation interface device receives natural language input 1112 from a user indicating a desired change to a home automation service. The particular home automation interface device provides that natural language input 1112 to a routing process 1120 that includes an audio pipeline 1122, a sentence classifier (semantic router) 1124, an agent registry 1126, and/or other components. The audio pipeline 1122 provides ASR functionality that converts the natural language input into a text representation, and TTS functionality that converts generated text into a natural language confirmation 1114 that can be played back. The audio pipeline 1112 may be a distributable component that can be executed locally on the particular home automation interface device 1110 that received the natural language input 1112, on a separate home automation controller 1140, on one or more other home automation interface devices (e.g., ones that did not receive the natural language input directly from the user) 1150, on other hardware devices in the home, and/or in the cloud. Depending on the implementation, the audio pipeline 1112 may be pre-assigned to execute on one or more of these devices, or dynamically assigned based on available processing resources, desired latency characteristics, and/or other criteria.

After the ASR functionality of the audio pipeline 1112 converts the natural language input into a text representation, the text representation is provided to the sentence classifier (semantic router) 1124, which makes an initial determination of semantic intent of the text representation and produces routing output that describes the qualities of an agent that may service what the user is requesting in the natural language input (e.g., a category of home automation, such as lighting, climate, music, etc. that the users request is related to, and accompanying metadata describing the request). Similar to the audio pipeline 1112, the sentence classifier (semantic router) 1124 may be a distributable component that can be executed locally on the particular home automation interface device 1110 that received the natural language input 1112, on a separate home automation controller 1140, on one or more other home automation interface devices (e.g., ones that did not receive the natural language input directly from the user) 1150, on other hardware devices in the home, and/or in the cloud. Depending on the implementation, the sentence classifier (semantic router) 1124 may be pre-assigned to execute on one or more of these devices, or dynamically assigned based on available processing resources, desired latency characteristics, and/or other criteria.

The agent registry 1126 maintains associations between categories of home automation (e.g., lighting, climate, music, etc.) and available agents of a pool of distributable agents, as well as information describing each agent's properties (e.g., capabilities, location, applicable policies, etc.). The routing process 1120 takes the routing output from the sentence classifier (semantic router) 1124 and the information in the agent registry 1126, and selects a target agent from the pool of distributable agents that is able to service the user's request. The selected agent may be one that is executing locally on the particular home automation interface device 1110 that received the natural language input 1112, on a separate home automation controller 1140, on one or more other home automation interface devices (e.g., ones that did not receive the natural language input directly from the user) 1150, on other hardware devices in the home, and/or in the cloud.

Once an agent 1130 is selected from the pool of distributable agent, an agent session is established that coordinates agent execution logic 1132, a generative AI engine 1134 and one or more service interfaces 1136. The agent execution logic 1132 controls overall execution of the agent's functionality. The generative AI engine 1134 determines detailed semantic intent from the text representation and generates structured data describing the desired change to the home automation service and text that can be used by the TTS functionality to produce a natural language confirmation 1114 indicating that the natural language input was understood. The service interfaces 1136 (e.g., model context protocol (MCP) servers or equivalent interfaces) generate function calls and/or service requests from the structured data and issue them to home automation controller code.

Similar to the audio pipeline 1112 and sentence classifier (semantic router) 1124 discussed above, the generative AI engine 1134 may be a distributable component that can be executed on one more devices that may differ from the device the rest of the agent 1130 is executed on. The generative AI engine 1134 may be executed on the particular home automation interface device 1110 that received the natural language input 1112, on a separate home automation controller 1140, on one or more other home automation interface devices (e.g., ones that did not receive the natural language input directly from the user) 1150, on other hardware devices in the home, and/or in the cloud. Depending on the implementation, the generative AI engine 1134 may be pre-assigned to execute on one or more of these devices, or dynamically assigned, based on available processing resources, desired latency, privacy/security criteria, differing cognitive, generalization or reasoning capabilities, and/or other criteria. In some implementations, different size generative AI engine 1134 may be available for execution on different types of devices to provide different amounts of cognitive, generalization or reasoning capabilities. For example, a “small” generative AI engine 1134 may be assigned to execute on a hardware devices in the home that has limited processing power when low latency (i.e. high responsiveness) and privacy are the primary criteria, while a “large” generative AI engine 1134 may be assigned to execute in the cloud when maximum cognitive and reasoning capabilities are the primary criteria.

The agent 1130 may provide text from the generative AI engine 1134 to the TTS functionality of the audio pipeline 1122 to produce a natural language confirmation 1114 indicating that the natural language input 1112 was understood. That natural language confirmation 1114 may be passed to the home automation input device 1110 so that it may be played on a speaker to the user. In one implementation, the natural language confirmation is played by a separate speaker that communicates with the home automation input device 1110 via a communications interface (e.g., Bluetooth/BLE). In an alternative implementation, the natural language confirmation is played by a speaker integrated into the home automation input device 1110.

In addition, the service interfaces 1136 (e.g., MCP servers) issue the function calls and/or service requests described in the structured data to home automation controller code that executes them to implement the desired change to the home automation service. Similar to other embodiments discussed above, the home automation controller code may be executed locally on the particular home automation interface device 1110 that received the natural language input 1112, on a separate home automation controller 1140, on one or more other home automation interface devices (e.g., ones that did not receive the natural language input directly from the user) 1150, on other hardware devices in the home, and/or in the cloud.

It should be understood that additional extension, adaptations, and the like may be readily made to made to the above embodiments. While it is described above that functionality may be implemented in a specific manner by specific software on specific hardware, it should be understood that functionality may also be implemented in different manners by different software on different hardware. Software may include instructions in a high-level programming language or low-level programming language that may be stored and compiled or interpreted to run on hardware. Instructions may be stored on a non-transitory electronic device readable medium and when executed on one or more processors implement the functionality.

It should be understood that the ordering of any steps discussed above may be changed to suit various situations or requirements. Absent an explicit indication to the contrary, the order of steps described above may be modified such that a subsequent step occurs before a preceding step, or in parallel to such step.

Above all, it should be understood that the above descriptions are meant to be taken only by way of example. What is claimed is:

1. A method for controlling a home automation service provided by a home automation system, comprising:
receiving, at a home automation interface device, natural language input from a user indicating a desired change to the home automation service, wherein the home automation interface device is a keypad, a smartphone, a remote control or remote control base unit, or an electrical panel controller;
passing, by the home automation interface device, the natural language input to processes and/or agents that include a generative artificial intelligence (AI) engine executing on one or more cloud-based or local computing devices;
producing structured data by the generative AI engine, wherein the structured data describes one or more function calls and/or service requests and one or more arguments for the change to the home automation service;
providing the structured data to a home automation controller, wherein the home automation controller is the keypad, the remote control or remote control base unit, the electrical panel controller, or a dedicated home automation controller; and
executing, by the home automation controller, the one or more function calls and/or service requests to implement the desired change to the home automation service.

2. The method of claim 1, further comprising:
receiving, at the home automation interface device, a natural language confirmation back from the generative AI engine, the natural language confirmation indicating that the natural language input was understood; and
playing the natural language confirmation on a speaker to the user.

3. The method of claim 1, wherein the generative AI engine is part of a particular agent of a pool of distributable agents, and the passing further comprises:
determining, by a sentence classifier, routing output that describes qualities of an agent that may service what the user is requesting in the natural language input; and
selecting the particular agent by comparing the routing output and information in an agent registry describing properties of each of the agents of the pool of distributable agents.

4. The method of claim 3, wherein the pool of distributable agents includes agents that are executed on the home automation interface device, on a separate home automation controller, on one or more other home automation interface devices or in the cloud.

5. The method of claim 1, wherein the processes and/or agents include a plurality of distributable components that are executable on the home automation interface device, on a separate home automation controller, on one or more other home automation interface devices or in the cloud, and the generative AI engine is a distributable component.

6. The method of claim 5, wherein each distributable component is dynamically assigned based on available processing resources and/or desired latency characteristics to execute on the home automation interface device, the separate home automation controller, the one or more other home automation interface devices, or the cloud.

7. The method of claim 1, wherein the home automation interface device is the keypad and the receiving the natural language input comprises recording the natural language input by a microphone integrated into the keypad or a device coupled to the keypad.

8. The method of claim 7, wherein the home automation controller is also the keypad and the executing the one or more function calls and/or service requests comprises issuing control commands from the keypad to one or more home automation devices to implement the desired change to the home automation service.

9. The method of claim 1, wherein the home automation interface device is the smartphone and the home automation controller is the keypad, the receiving the natural language input comprises recording the natural language input by a microphone integrated into the smartphone, and the executing the one or more function calls and/or service requests comprises issuing control commands from the keypad or the remote control base unit to one or more home automation devices to implement the desired change to the home automation service.

10. The method of claim 1, wherein the home automation interface device is the remote control base unit and the receiving the natural language input comprises recording the natural language input by a microphone integrated into the remote control base unit or a device coupled to remote control base unit.

11. The method of claim 10, wherein the device coupled to the keypad is a remote control associated with the remote control base unit.

12. The method of claim 10, wherein the home automation controller is also the remote control base unit and the executing the one or more function calls and/or service requests comprises issuing control commands from the remote control base unit to one or more home automation devices to implement the desired change to the home automation service.

13. The method of claim 1, wherein the home automation controller is the electrical panel controller, and the executing the one or more function calls and/or service requests comprises issuing control commands from the electrical panel controller to one or more home automation devices to implement the desired change to the home automation service.

14. The method of claim 1, wherein the home automation service is a lighting service, and the desired change to the home automation service is a change to one or more of an illumination level, a color, or a color temperature of one or more lighting devices.

15. The method of claim 1, wherein the home automation service is a music service, and the desired change to the home automation service is to play a specified type of audio from a streaming or on-demand music service on one or more speakers.

16. The method of claim 1, wherein the home automation service is an energy monitoring and management service, and the desired change to the home automation service is to change the energy source or energy utilization of one or more devices or to provide energy utilization data about one or more devices.

17. The method of claim 16, further comprising:
accessing, by the home automation controller, historical energy utilization data from a cloud-based or local data repository; and
determining an energy utilization response from the historical energy utilization data.

18. A keypad configured to control a home automation service provided by a home automation system, comprising:
one or more buttons for receiving user input;
one or more communications interfaces; and
an application processor configured to
receive, via the one or more communications interfaces of the keypad from a device that includes a microphone, natural language input from a user indicating a desired change to the home automation service,
pass, via the one or more communications interfaces of the keypad, the natural language input to a generative artificial intelligence (AI) engine,
receive, via the one or more communications interfaces of the keypad, structured data back from the generative AI engine, wherein the structured data describes one or more function calls and/or service requests and one or more arguments for the change to the home automation service, and
execute the one or more function calls and/or service requests to implement the desired change to the home automation service.

19. The keypad of claim 18, wherein the application processor is further configured to:
receive, via the one or more communications interfaces of the keypad, a natural language confirmation back from the generative AI engine, the natural language confirmation indicating that the natural language input was understood; and
cause the natural language confirmation to be played on a speaker to the user.

20. A remote control base unit configured to control a home automation service provided by a home automation system, comprising:
a remote control charging circuit and charging contacts for charging a remote control;
one or more communications interfaces; and
an application processor configured to
receive, via the one or more communications interfaces of the remote control base unit from a device that includes a microphone, natural language input from a user indicating a desired change to the home automation service,
pass, via the one or more communications interfaces of the remote control base unit, the natural language input to a generative artificial intelligence (AI) engine,
receive, via the one or more communications interfaces of the remote control base unit, structured data back from the generative AI engine, wherein the structured data describes one or more function calls and/or service requests and one or more arguments for the change to the home automation service, and
execute the one or more function calls and/or service requests to implement the desired change to the home automation service.

21. The remote control base unit of claim 20, wherein the application processor is further configured to:
receive, via the one or more communications interfaces of the remote control base unit, a natural language confirmation back from the generative AI engine, the natural language confirmation indicating that the natural language input was understood; and
cause the natural language confirmation to be played on a speaker to the user.
